(19) United States
(12) Patent Application Publication
(10) Pub. No.: US 2025/0310676 A1
(43) Pub. Date: Oct. 2, 2025

(54) SYSTEM AND METHOD FOR AN IN-EAR EARPHONE WITH AN EXTERNAL SOUND-PERMITTING TIP HAVING OPEN AIR CHANNELS

(71) Applicant: Dell Products LP, Round Rock, TX (US)

(72) Inventors: Eng Kang Chng, Singapore (SG); Peng Lip Goh, Singapore (SG); You-Yu Lin, Sanchong Dist. (TW)

(73) Assignee: Dell Products LP, Round Rock, TX (US)

(21) Appl. No.: 18/620,634

(22) Filed: Mar. 28, 2024

(51) Int. Cl. H04R 1/10

(52) U.S. Cl. CPC H04R 1/1016; H04R 1/1041; H04R 1/1075; H04R 1/1083; H04R 2420/07; H04R 2460/01; H04R 2460/09

(57) ABSTRACT

An in-ear earphone includes a digital signal processor (DSP), a speaker operatively coupled to the DSP; an external microphone operatively coupled to the DSP, and an in-ear earphone power management unit (PMU) to provide power to the DSP the speaker, and the external microphone. The in-ear earphone includes an earphone in-ear external sound-permitting tip operatively coupled to the in-ear earphone, the earphone in-ear external sound-permitting tip for insertion into a user's ear canal and including tip channels to allow noise to enter into the user's ear canal. The DSP executes computer-readable program code of a noise cancelling module to cancel, from audio input from the external microphone, sounds external to a user's ear canal.

### FIELD OF THE DISCLOSURE

The present disclosure generally relates to in-ear earphones such as earbuds. More specifically, the present specification describes an in-ear earphone with an external sound-permitting tip having open air channels.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more applications such as a gaming application. Further, the information handling system may be operatively coupled to a set of earphones that provide audio output to a user and may receive audio input.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system including in-ear earphones that includes an earphone in-ear external sound-permitting tip that includes tip channels to allow for an amount of noise to enter into the user's ear canal raising awareness to the user's surrounding according to an embodiment of the present disclosure;

FIG. 2A is a graphic diagram depicting a proximal end of an earphone in-ear external sound-permitting tip that includes tip channels to allow for an amount of noise to enter into the user's ear canal raising awareness to the user's surrounding according to an embodiment of the present disclosure;

FIG. 2B is a graphic diagram depicting a distal end of an earphone in-ear external sound-permitting tip that includes tip channels to allow for an amount of noise to enter into the user's ear canal raising awareness to the user's surrounding according to another embodiment of the present disclosure;

FIG. 3A is a graphic diagram depicting a front perspective view of an in-ear earphone that includes an earphone in-ear external sound-permitting tip that includes tip channels to allow for an amount of noise to enter into the user's ear canal raising awareness to the user's surrounding according to an embodiment of the present disclosure;

FIG. 3B is a graphic diagram depicting a side perspective view of an in-ear earphone that includes an earphone in-ear external sound-permitting tip that includes tip channels to allow for an amount of noise to enter into the user's ear canal raising awareness to the user's surrounding according to another embodiment of the present disclosure;

FIG. 4 is a graphic diagram of an in-ear earphone placed within a user's ear and ear canal that includes an earphone in-ear external sound-permitting tip according to another embodiment of the present disclosure; and

FIG. 5 is a flow chart showing a method of assembling an in-ear earphone that includes an earphone in-ear external sound-permitting tip having tip channels to allow for an amount of noise to enter into the user's ear canal raising awareness to the user's surrounding according to another embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems may be operatively coupled to a plurality of input and output devices that allow a user to interact with the information handling system. The types of input may include cursor movement and selection input from a mouse and/or trackpad, keystroke input from a keyboard, and audio input into a microphone, and audio output at a speaker or other speaker driver. In an embodiment, audio output may be provided to, and audio input received by, a user via an in-ear earphone or set of earphones that are placed within the user's ear and, at least partially, into the ear canals of the user. Often, the purpose of having in-ear earphones that are passed, at least partially, into the user's ear canal is to seal the user's ear canal from outside noises using a rubber or plastic tip. This rubber or plastic tip not only acts as a cushion while inserted into the user's ear canal but also prevents external sounds from being introduced into the user's ear canal thereby distorting the audio presented by the speaker at the set of earphones. However, this sealing at the user's ear canal using the earphone tip prevents the user from being aware of the user's surroundings including traffic on a street, other user's attempting to get the user's attention, as well as other noises that may make the user aware of potential dangers and/or require the user's attention. Certain in-ear earphones may use a transparency mode that turns off any active noise cancellation allowing an external microphone to provide external sounds to the user's ears along with the audio provided from the information handling system. However, this transparency mode does not feel natural to the user and may consume additional power when executed in order to allow a user to hear those external sounds.

Some headphones and earphones may include structures that open the user's ear canal so that the user may hear external sounds. These structures may require, in some embodiments, devices that hang the earphones over the outer ear. This may interfere with, for example, a user's eyeglasses or other accessories and may also degrade the audio quality due to the speaker and microphone being shifted away from the user's ear canal. Still further, these hanging earphones may be shifted further towards and away from the user's ear canal as the user moves the user's head thereby increasing the degradation of the audio heard by the user.

The present specification describes an in-ear earphone that includes a digital signal processor (DSP), a speaker operatively coupled to the DSP, an external microphone operatively coupled to the DSP, and an in-ear earphone power management unit (PMU) to provide power to the DSP the speaker, and the external microphone. The in-ear earphone also includes an in-ear tip operatively coupled to the in-ear earphone, the earphone in-ear external sound-permitting tip comprising tip channels to allow noise to enter into the user's ear canal according to embodiments of the present disclosure. In an embodiment, the tip channels are formed along the external surface of the earphone in-ear external sound-permitting tip and run the length of the earphone in-ear external sound-permitting tip. In another embodiment, the tip channels run the length of the earphone in-ear external sound-permitting tip and increase in width closer to a proximal end of the earphone in-ear external sound-permitting tip. The formation of the tip channels along the outer surface of the earphone in-ear external sound-permitting tips allow for an amount of ambient sounds to enter into the user's ear canal thereby raising awareness to the user of surrounding dangers and events that otherwise would not be noticeable by the user.

In an embodiment, the DSP of the in-ear earphone may execute computer-readable program code of a noise cancelling module to cancel, from audio input from at least one external microphone, sounds external to a user's ear canal. With the at least one external microphone being placed at an external entrance of one or more tip channels to capture the sounds immediately external to the user's ear canal as input to the DSP executing the noise cancelling module, the DSP may selectively cancel some of the noise and sounds while still allowing the user to detect some ambient noises thereby providing a level of awareness to the user. Still further, by still having the earphone in-ear external sound-permitting tips placed within the user's ear canals, the issues with location shifting of the external microphone and speaker that arise with open ear type earphones may be minimized, thereby maintaining a consistent audio experience for the user.

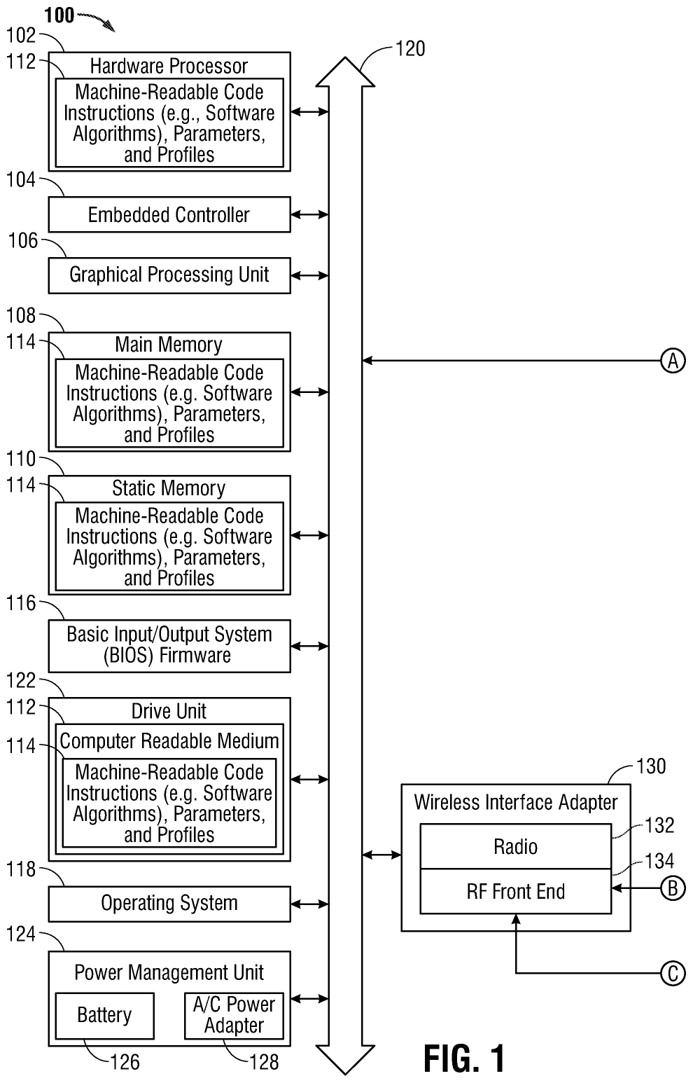

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 140, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 108, (volatile (e.g., random-access memory, etc.), or static memory 110, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, or any combination thereof. Additional components of the information handling system 100 may include one or more storage devices such as static memory 110 or drive unit 122. The information handling system 100 may include or interface with one or more communications ports for communicating with external devices, as well as various input and output (I/O) devices 144, such as a docking station 156, a mouse 154, a trackpad 152, a stylus 150, a keyboard 148, a video/graphics display device 146, in-ear earphones 158, or any combination thereof. Portions of an information handling system 100 may themselves be considered information handling systems 100.

Information handling system 100 may include devices or modules that embody one or more of the devices or execute instructions for one or more systems and modules. The information handling system 100 may execute instructions (e.g., software algorithms), parameters, and profiles 114 that may operate on servers or systems, remote data centers, or on-box in individual client information handling systems according to various embodiments herein. In some embodiments, it is understood any or all portions of instructions (e.g., software algorithms), parameters, and profiles 114 may operate on a plurality of information handling systems 100.

The information handling system 100 may include the hardware processor 102 such as a central processing unit (CPU). Any of the processing resources may operate to execute code that is either firmware or software code. Moreover, the information handling system 100 may include memory such as main memory 108, static memory 110, and disk drive unit 122 (volatile (e.g., random-access memory, etc.), nonvolatile memory (read-only memory, flash memory etc.) or any combination thereof or other memory with computer readable medium 112 storing instructions (e.g., software algorithms), parameters, and profiles 114 executable by the hardware processor 102, EC 104, GPU 106, or any other hardware processing device. The information handling system 100 may also include one or more buses 120 operable to transmit communications between the various hardware components such as any combination of various I/O devices 144 as well as between hardware processors 102, an EC 104, the operating system (OS) 118, the basic input/output system (BIOS) 116, the wireless interface adapter 130, or a radio module, among other components described herein. In an embodiment, the hardware processor 102, EC 104, and/or GPU 106 may execute one or more bus drivers in order to transmit this data between the information handling system 100 and the input/output devices 144 described herein. In an embodiment, the information handling system 100 may be in wired or wireless communication with the I/O devices 144 such as in-ear earphones 158, a keyboard 148, a mouse 154, video display device 146, stylus 150, or trackpad 152 among other peripheral devices.

As described herein, the information handling system 100 further includes a video/graphics display device 146. The video/graphics display device 146 in an embodiment may function as a liquid crystal display (LCD), an organic light emitting diode (OLED), a flat panel display, or a solid-state display. It is appreciated that the video/graphics display device 146 may be wired or wireless and may be an external video/graphics display device 146 that allows a user to increase the desktop area by extending the desktop in an embodiment. Additionally, as described herein, the information handling system 100 may include or be operatively coupled to a cursor control device (e.g., a trackpad 152, or gesture or touch screen input), a stylus 150, and/or a keyboard 148, among others that allows the user to interface with the information handling system 100 via the video/graphics display device 146. Information handling system 100 may also be operatively coupled to a peripheral device 144 such as the in-ear earphones 158 or other smart peripheral device having a hardware processing device such as a hardware processor, microcontroller, or other hardware processing resource and which may be further operatively coupled to one or more additional peripheral devices 144. Various drivers and hardware control device electronics may be operatively coupled to operate the I/O devices 144 according to the embodiments described herein. The present specification contemplates that the I/O devices 144 may be wired or wireless.

A network interface device of the information handling system 100 shown as wireless interface adapter 130 can provide connectivity among devices such as with Bluetooth® or to a network 138, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136-1, 136-2 is used to communicate with the wireless peripheral devices such as the wireless in-ear earphones 158 of embodiments herein via, for example, a Bluetooth® or Bluetooth® Low Energy (BLE) protocols. The wireless in-ear earphones 158 may include an in-ear earphone radio 168 to wireless link to the wireless interface device 130 of the information handling system 100 in embodiments herein. The wireless in-ear earphones 158 may include the in-ear earphone radio 168 to wireless link to a second wireless in-ear earphone of a pair of wireless in-ear earphones to both communicate with the wireless interface device 130 of the information handling system 100 in embodiments herein. In an embodiment, the WAN, WWAN, LAN, and WLAN may each include an AP 140 or base station 142 used to operatively couple the information handling system 100 to a network 138. In a specific embodiment, the network 138 may include macro-cellular connections via one or more base stations 142 or a wireless AP 140 (e.g., Wi-Fi), or such as through licensed or unlicensed WWAN small cell base stations 142. Connectivity may be via wired or wireless connection. For example, wireless network wireless APs 140 or base stations 142 may be operatively connected to the information handling system 100. Wireless interface adapter 130 may include one or more radio frequency (RF) subsystems (e.g., radio 132) with transmitter/receiver circuitry, modem circuitry, one or more antenna radio frequency (RF) front end circuits 134, one or more wireless controller circuits, amplifiers, antennas 136-1, 136-2 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, or similar wireless standards may be used. Wireless interface adapter 128 may connect to any combination of macro-cellular wireless connections including 2G, 2.5G, 3G, 4G, 5G or the like from one or more service providers. Utilization of radio frequency communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, software, firmware, dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes instructions, parameters, and profiles 114 or receives and executes instructions, parameters, and profiles 114 responsive to a propagated signal, so that a hardware device connected to a network 138 may communicate voice, video, or data over the network 138. Further, the instructions 114 may be transmitted or received over the network 138 via the network interface device or wireless interface adapter 130.

The information handling system 100 may include a set of instructions 114 that may be executed to cause the computer system to perform any one or more of the methods or computer-based functions disclosed herein such as software applications that utilize or provide audio data via the in-ear earphones 158. For example, instructions 114 may be executed by a hardware processor 102, GPU 106, EC 104 or any other hardware processing resource and may include software agents, or other aspects or components used to execute the methods and systems described herein. Various software modules comprising application instructions 114 may be coordinated by an OS 118, and/or via an application programming interface (API) include a unified device API described herein. An example OS 118 may include Windows®, Android®, and other OS types. Example APIs may include Win 32, Core Java API, or Android APIs.

In an embodiment, the information handling system 100 may include a disk drive unit 122. The disk drive unit 122 and may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106 or EC 104, or other microcontroller unit to perform the processes described herein. Similarly, main memory 108 and static memory 110 may also contain a computer-readable medium for storage of one or more sets of machine-readable code instructions, parameters, or profiles 114 described herein. The disk drive unit 122 or static memory 110 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 108, the static memory 110, and/or within the disk drive 122 during execution by the hardware processor 102, EC 104, or GPU 106 of information handling system 100.

Main memory 108 or other memory of the embodiments described herein may contain computer-readable medium (not shown), such as RAM in an example embodiment. An example of main memory 108 includes random access memory (RAM) such as static RAM (SRAM), dynamic RAM (DRAM), non-volatile RAM (NV-RAM), or the like, read only memory (ROM), another type of memory, or a combination thereof. Static memory 110 may contain computer-readable medium (not shown), such as NOR or NAND flash memory in some example embodiments. The applications and associated APIs, for example, may be stored in static memory 110 or on the disk drive unit 122 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 124 (a.k.a. a power supply unit (PSU)). The PMU 124 may include a hardware controller and executable machine-readable code instructions to manage the power provided to the components of the information handling system 100 such as the hardware processor 102 and other hardware components described herein. The PMU 124 may control power to one or more components including the one or more drive units 122, the hardware processor 102 (e.g., CPU), the EC 104, the GPU 106, a video/graphic display device 146, or other wired I/O devices 144 such as the mouse 154, the stylus 150, the keyboard 148, the in-ear earphones 158, the speaker 172, and the trackpad 152 and other components that may require power when a power button has been actuated by a user. In an embodiment, the PMU 124 may monitor power levels and be electrically coupled to the information handling system 100 to provide this power. The PMU 124 may be coupled to the bus 120 to provide or receive data or machine-readable code instructions. The PMU 124 may regulate power from a power source such as the battery 126 or AC power adapter 128. In an embodiment, the battery 126 may be charged via the AC power adapter 128 and provide power to the components of the information handling system 100, via wired connections as applicable, or when AC power from the AC power adapter 128 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 110 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 may be operatively coupled to a one or more in-ear earphones 158. In an embodiment, the in-ear earphones 158 may be separate devices that each include wireless communication abilities to both wirelessly communicate with the information handling system 100 and wirelessly communicate with each other such as via Bluetooth® or BLE protocols. Thus, in an embodiment, the in-ear earphones 158 may be a set of in-ear earphones 158 with one of each of the in-ear earphones 158 being placed within each of the user's ears so that the user may listen to audio output at individual speakers 164 within each in-ear earphone 158. In an embodiment each of the in-ear earphones 158 may include an in-ear earphone radio 168 and in-ear earphone antenna 170 that allow for this communication wirelessly. The in-ear earphone radio 168 may be operatively coupled to a DSP 160 located within each of the in-ear earphones 158 such that wireless communications can be sent and received from each of the information handling system 100 and the individual in-ear earphones 158. In other embodiments, the in-ear earphones 158 may be wired.

In an embodiment, each of the in-ear earphones 158 may include a housing that houses the components described herein including the DSP 160, the speaker 164, one or more external microphones 166, the in-ear earphone radio 168, the in-ear earphone antenna 170, an in-ear earphone PMU 172, and an in-ear earphone battery 174 or power source. In an embodiment, the housing of the in-ear earphones 158 may be made of a plastic to reduce the weight of the in-ear earphones 158.

As described herein, the in-ear earphones 158 includes a DSP 160 to execute computer-readable program code for firmware or software including the computer-readable program code of the noise cancellation module 162 as described herein. The DSP 160 may be operatively coupled to the speaker 164 so that audio output to the speaker 164 and to the user may be controlled as provided to the in-ear earphones 158 via the information handling system 100. Additionally, the DSP 160 may be operatively coupled to one or more external microphones 166 that pick up voice audio input from a user or other sounds external to the user's ear canal. The input from at least one external microphone 166 may be processed by the DSP 160 executing the computer-readable program code of the noise cancellation module 162 to reduce the external sounds heard by the user wearing the in-ear earphones 158 such as through tip channels 178 formed into the earphone in-ear external sound-permitting tips 176 as described in embodiments herein.

The housing of the in-ear earphones 158 may further include a tip extension 182 onto which an earphone in-ear external sound-permitting tip 176 may be operatively coupled. In an example embodiment, the in-ear earphones 158 may be purchased by the user that include a set of earphone in-ear external sound-permitting tips 176 for each of the in-ear earphones 158 and may include a variety of different sizes that provide the user with different size options such that the earphone in-ear external sound-permitting tips 176 may fit comfortably into the user's ear canals. As described herein, the earphone in-ear external sound-permitting tips 176 may have one or more tip channels 178 formed into the earphone in-ear external sound-permitting tip 176. Multiple choices of earphone in-ear external sound-permitting tips 176 with differing number of tip channels 178 may be offered to customize the level of external sound allowed into the user's ear canal in some embodiments. In an embodiment, the tip channels 178 are formed along the external surface of the earphone in-ear external sound-permitting tip 176 and run the length of the earphone in-ear external sound-permitting tip 176 such that plural channel airways are created that extend from the exterior of the earphone in-ear external sound-permitting tip 176 and into the user's ear canal. In another embodiment, the tip channels 178 run the length of the earphone in-ear external sound-permitting tip 176 and increase in width closer to a proximal end of the earphone in-ear external sound-permitting tip 176 that is within the user's ear canal. In such an embodiment, this gradual increase or any changes in the width of the tip channels 178 along the length of the tip channels 178 may provide acoustic characteristics that can be used to change the characteristics of the sound as it passes through the tip channels 178 and into the user's ear.

In an embodiment, the DSP 160, speaker 164, in-ear earphone radio 168, and external microphone 166 may be powered via the in-ear earphone PMU 172. The in-ear earphone PMU 172 may include a hardware controller and executable machine-readable code instructions to manage the power provided to the components of the in-ear earphones 358 such as the DSP 160 and other hardware components described herein. The in-ear earphone PMU 172 may control power to these components within the in-ear earphones 158. In an embodiment, the in-ear earphone PMU 172 may monitor power levels. The in-ear earphone PMU 172 may regulate power from a power source such as in-ear earphone battery 174. In an embodiment, the in-ear earphone battery 174 may be charged via an AC power source such as that found in a carrying case for the in-ear earphones 158 in an example embodiment.

In an embodiment, the earphone in-ear external sound-permitting tip 176 may be secured to the tip extension 182 of the housing of the in-ear earphones 158 via use of a clipping channel 180 formed into an internal barrel of the earphone in-ear external sound-permitting tip 176. An internal surface of the internal barrel of the earphone in-ear external sound-permitting tip 176 may include a clipping channel 180 that interfaces with a clipping shelf 184 formed onto the tip extension 182. During operation, the internal barrel of the earphone in-ear external sound-permitting tip 176 may be force fitted over an external surface of the tip extension 182 until the clipping shelf 184 formed on the tip extension 182 fits into the clipping channel 180 formed on the internal surface of the internal barrel of the earphone in-ear external sound-permitting tip 176.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

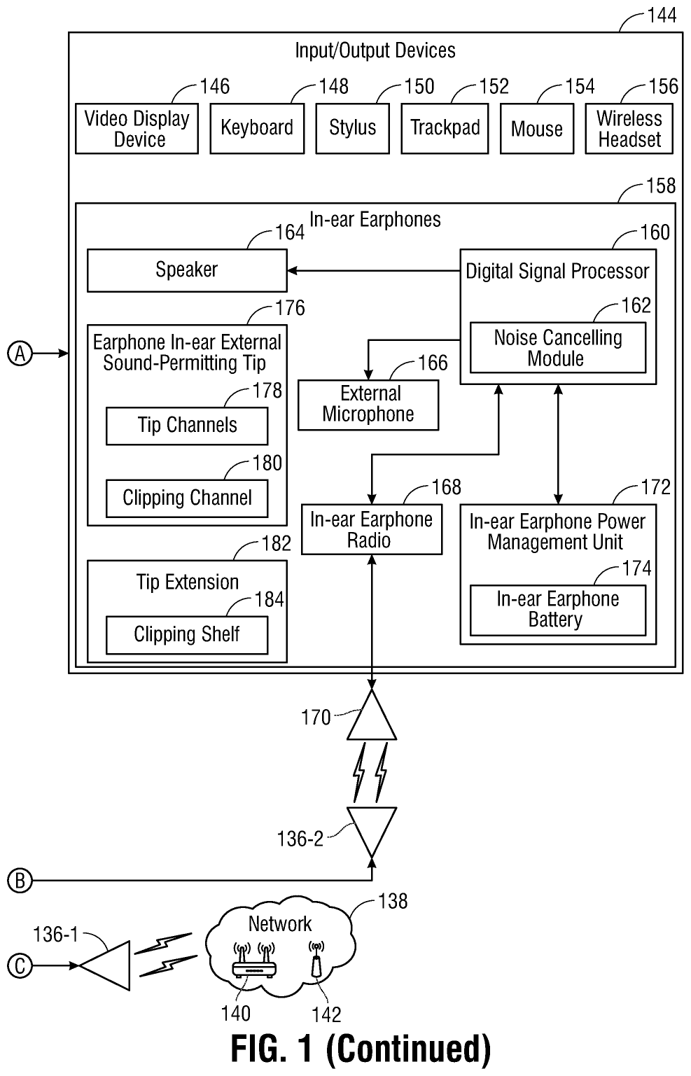

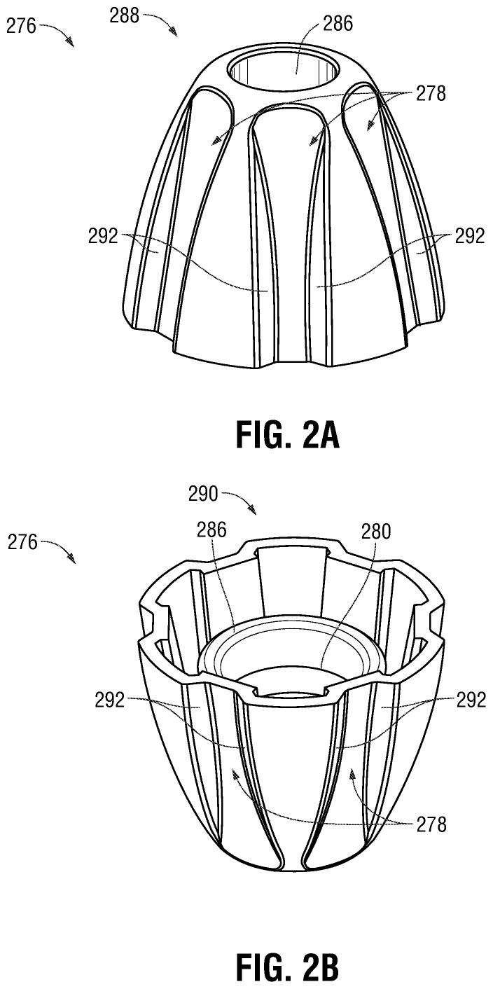

FIG. 2A is a graphic diagram depicting a proximal end 288 of an earphone in-ear external sound-permitting tip 276 that includes tip channels 278 creating an airway to allow for an amount of noise to enter into the user's ear canal raising awareness to the user's surrounding according to an embodiment of the present disclosure. Additionally, FIG. 2B is a graphic diagram depicting a distal end of an earphone in-ear external sound-permitting tip that includes tip channels creating an airway to allow for an amount of noise to enter into the user's ear canal raising awareness to the user's surrounding according to another embodiment of the present disclosure. As described herein, the earphone in-ear external sound-permitting tips 276 shown in FIGS. 2A and 2B may be operatively coupled to tip extensions formed on a housing of the in-ear earphones described herein.

In an embodiment shown, the earphone in-ear external sound-permitting tips 276 shown in FIGS. 2A and 2B includes six tip channels 278 formed on an exterior surface of the earphone in-ear external sound-permitting tips 276. These tip channels 278 run the entire length of the earphone in-ear external sound-permitting tips 276 from the distal end 290 to the proximal end 288 of each of the earphone in-ear external sound-permitting tips 276. Although FIGS. 2A and 2B show six tip channels 278 formed into the exterior surface of the earphone in-ear external sound-permitting tips 276, the present specification contemplates that more or fewer tip channels 278 may be formed into the exterior surface of the earphone in-ear external sound-permitting tips 276 to alter levels of outside noise allowed in. In the embodiment shown in FIGS. 2A and 2B, the width of the tip channels 278 formed in the exterior surface of the earphone in-ear external sound-permitting tips 276 have a first width at the distal end 290 of the earphone in-ear external sound-permitting tips 276 and a second width at the proximal end 288 of the earphone in-ear external sound-permitting tips 276. In an embodiment, the width of the tip channels 278 increases, gradually, from the distal end 290 to the proximal end 288. The tip channels 278 may be a variety of widths and different tapering in embodiments herein. It is appreciated that any number of tip channels 278 are contemplated and can be fewer for less amount of surrounding noises allowed into the user's ear canal in embodiments herein. In other embodiments, one or more tip channels 78 can be narrower or wider. Any combination of sizes and numbers of tip channels 278 is contemplated in the present specification.

In an embodiment, the formation of the tip channels 278 into the external surface of the earphone in-ear external sound-permitting tips 276 also creates tip channel walls 292. The tip channel walls 292 may act as a support structure to brace the earphone in-ear external sound-permitting tip 276 between the tip extension of the in-ear earphone and the user's ear canal. In other embodiments, the tip channel walls 292 may be formed perpendicular from the exterior surface of the earphone in-ear external sound-permitting tip 276. In an embodiment, the tip channel walls 292 may be formed at an angle including any angle from 30 degrees to 120 degrees away from the exterior surface of the earphone in-ear external sound-permitting tip 276.

As described herein, the earphone in-ear external sound-permitting tips 276 may also include an internal barrel 286 formed within the earphone in-ear external sound-permitting tips 276. The internal barrel 286 forms an internal pass-through cavity of the earphone in-ear external sound-permitting tip 276 from the distal end 290 through to the proximal end 288 of the earphone in-ear external sound-permitting tips 276 such that the form of the internal barrel 286 double backs into the interior of the exterior surface of the earphone in-ear external sound-permitting tip 276. The internal barrel 286, in an embodiment, is used to operatively couple the earphone in-ear external sound-permitting tips 276 to the tip extensions formed on the housing of the in-ear earphones as described herein. In an embodiment, the internal barrels 286 may include a clipping channel 280 into which a clipping shelf formed onto an exterior surface of the tip extension is placed into when the earphone in-ear external sound-permitting tips 276 are operatively coupled onto the tip extensions of the in-ear earphones. The distance between a terminal end of the internal barrel 286 and the clipping channel 280 may define the distance that the earphone in-ear external sound-permitting tips 276 are to be moved onto the exterior surface of the tip extensions of each of the in-ear earphone 258.

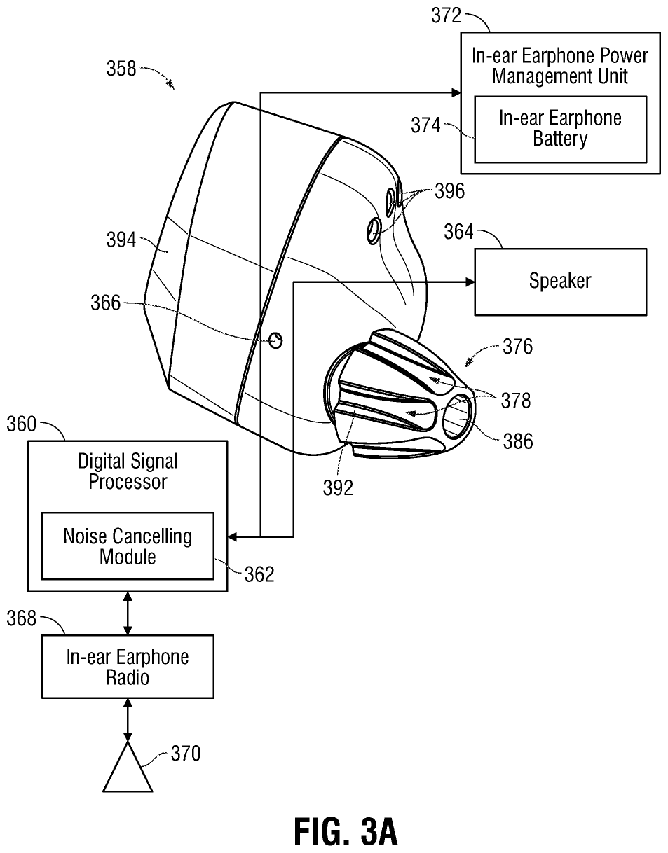

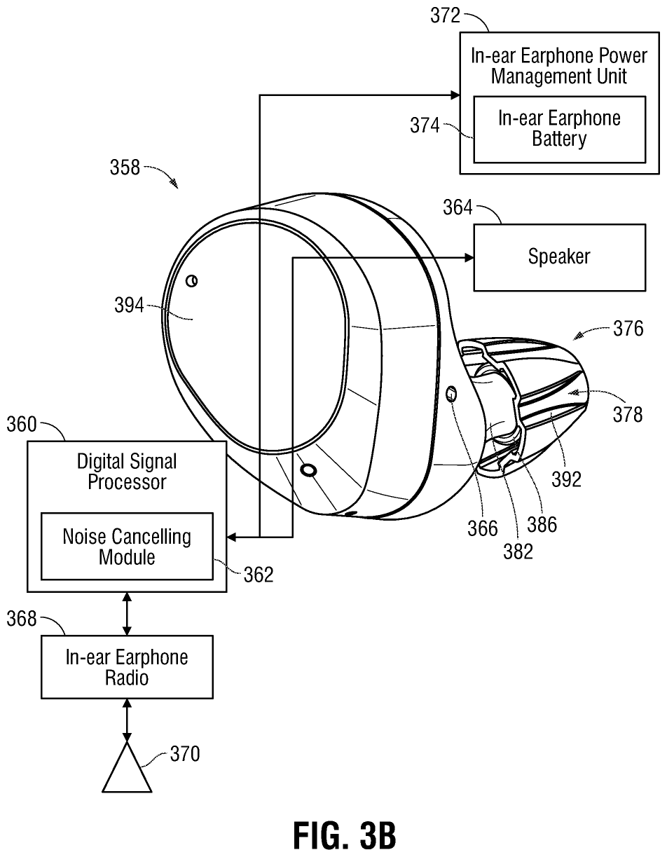

FIG. 3A is a graphic diagram depicting a perspective front view of and block diagram of an in-ear earphone 358 that includes an earphone in-ear external sound-permitting tip 376 that includes tip channels 378 to allow for an amount of noise to enter into the user's ear canal raising awareness to the user's surrounding according to an embodiment of the present disclosure. Additionally, FIG. 3B is a graphic diagram depicting a perspective side view of and block diagram of an in-ear earphone 358 that includes an earphone in-ear external sound-permitting tip 376 that includes tip channels 378 to allow for an amount of noise to enter into the user's ear canal raising awareness to the user's surrounding according to another embodiment of the present disclosure. It is appreciated that although FIGS. 3A and 3B show a single in-ear earphone 358 (e.g., an in-ear earphone 358 for a right ear of the user), another in-ear earphone 358 may be included with the in-ear earphone 358 to serve as a pair of in-ear earphones 358. Additionally, in an embodiment, a carrying case (not shown) may be used to store the in-ear earphones 358 when not in use. This carrying case, in an embodiment, may also serve to charge the in-ear earphone battery 374 within each of the in-ear earphones 358 via one or more charging pins 396 formed on an exterior surface of the in-ear earphones 358.

As described herein, the in-ear earphones 358 includes an in-ear earphone housing 394. The in-ear earphone housing 394 may be made of plastic in an example embodiment. In an embodiment, the in-ear earphone housing 394 may be used to contain those elements of the in-ear earphones 358 including the DSP 360, the speaker 364, one or more external microphones such as 366, the in-ear earphone radio 368, the in-ear earphone antenna 370, the in-ear earphone PMU 372, and the in-ear earphone battery 374. It is appreciated that other circuitry, printed circuit boards, and other circuit design elements may be used to operatively couple these devices and systems to each other. As described herein and with reference specifically to FIG. 3B in an example embodiment, the tip extension 382 may form part of the in-ear earphone housing 394 and extends away from the in-ear earphone housing 394 at a location where the in-ear earphones 358 is to extend into the user's ear canal.

As described herein, the in-ear earphones 358 includes a DSP 360 to execute computer-readable program code including the computer-readable program code of the noise cancellation module 362 described herein. The DSP 360 may be operatively coupled to the speaker 364 so that audio output to the speaker 364 and to the user may be controlled as provided to the in-ear earphones 358 via the information handling system such as that described in FIG. 1. Additionally, the DSP 360 may be operatively coupled to an external microphone 366 that picks up sounds external to the user's ear canal. The input from the external microphone 366 may be processed by the DSP 360 executing the computer-readable program code of the noise cancellation module 362 to reduce the external sounds heard by the user through tip channels 378 formed into the earphone in-ear external sound-permitting tips 376 as described herein.

The housing of the in-ear earphones 358 may further include a tip extension 382 onto which an earphone in-ear external sound-permitting tip 376 may be operatively coupled. In an example embodiment, the in-ear earphones 358 may be purchased by the user with that includes a set of earphone in-ear external sound-permitting tips 376 for each of the in-ear earphones 358 and may include a variety of different sizes that provide the user with different size options such that the earphone in-ear external sound-permitting tips 376 may fit comfortably into the user's ear canals. It is appreciated that the earphone in-ear external sound-permitting tips 376 may include different number of top channels 378 or different sizes of top channels 378 for various external noise permitting profiles. In one embodiment, the earphone in-ear external sound-permitting tips 376 shown in FIGS. 3A and 3B include six tip channels 378 formed on an exterior surface of the earphone in-ear external sound-permitting tips 376. These tip channels 378 run the entire length of the earphone in-ear external sound-permitting tips 376 from the distal end (e.g., 290, FIGS. 2B) to the proximal end (e.g., 288, FIG. 2A) of each of the earphone in-ear external sound-permitting tips 376. Although FIGS. 3A and 3B show six tip channels 378 formed into the exterior surface of the earphone in-ear external sound-permitting tips 376, the present specification contemplates that more or fewer tip channels 378 may be formed into the exterior surface of the earphone in-ear external sound-permitting tip 376 and may be formed to provide for differing levels of permitted external noise levels to pass into a user's ear canal. In the embodiment, the width of the tip channels 378 formed in the exterior surface of the earphone in-ear external sound-permitting tips 376 have a first width at the distal end of the earphone in-ear external sound-permitting tips 376 and a second width at the proximal end of the earphone in-ear external sound-permitting tips 376. In an embodiment, the width of the tip channels 378 increases, gradually, from the distal end to the proximal end. It is appreciated that the tip channels 378 may include a variety of widths and different tapering in embodiments herein in order to provide for a variety of differing external noise level profiles that allow external noises into the user's ear canal.

In an embodiment, the formation of the tip channels 378 into the external surface of the earphone in-ear external sound-permitting tips 376 also creates tip channel walls 392. The tip channel walls 392 may act as a support structure to brace the earphone in-ear external sound-permitting tip 376 between the tip extension of the in-ear earphone and the user's ear canal. In one embodiment, the tip channel walls 392 may be formed perpendicular from the exterior surface of the earphone in-ear external sound-permitting tip 376. In other embodiments, the tip channel walls 392 may be formed at any angle away from the exterior surface of the earphone in-ear external sound-permitting tip 376 and the angles may vary along the length of the earphone in-ear external sound-permitting tip 376.

As described herein, the earphone in-ear external sound-permitting tips 376 may also include an internal barrel 386 formed within the earphone in-ear external sound-permitting tips 376. The internal barrel 386 is operatively coupled to the exterior surface of the earphone in-ear external sound-permitting tip 376 at the proximal end of the earphone in-ear external sound-permitting tips 376 such that the form of the internal barrel 386 double backs into the interior of the exterior surface of the earphone in-ear external sound-permitting tip 376. The internal barrel 386, in an embodiment, is used to operatively couple the earphone in-ear external sound-permitting tips 376 to the tip extensions 382 formed on the housing of the in-ear earphones as described herein. In an embodiment, the internal barrels 386 may include a clipping channel (not shown) into which a clipping shelf (not shown) formed onto an exterior surface of the tip extension 382 is placed into when the earphone in-ear external sound-permitting tips 376 are operatively coupled onto the tip extensions 382 of the in-ear earphones. The distance between a terminal end of the internal barrel 386 and the clipping channel 380 may define the distance that the earphone in-ear external sound-permitting tips 376 are to be moved onto the exterior surface of the tip extensions 382 of each of the in-ear earphone 358.

In an embodiment, the DSP 360, speaker 364, in-ear earphone radio 368, and one or more external microphones 366 may be powered via the in-ear earphone PMU 372. The in-ear earphone PMU 372 may include a hardware controller and executable machine-readable code instructions to manage the power provided to the components of the in-ear earphones 358 such as the DSP 360 and other hardware components described herein. The in-ear earphone PMU 372 may control power to these components within the in-ear earphones 358. In an embodiment, the in-ear earphone PMU 372 may monitor power levels. The in-ear earphone PMU 372 may regulate power from a power source such as in-ear earphone battery 374. In an embodiment, the in-ear earphone battery 374 may be charged via an AC power source such as that found in a carrying case for the in-ear earphones 358 in an example embodiment.

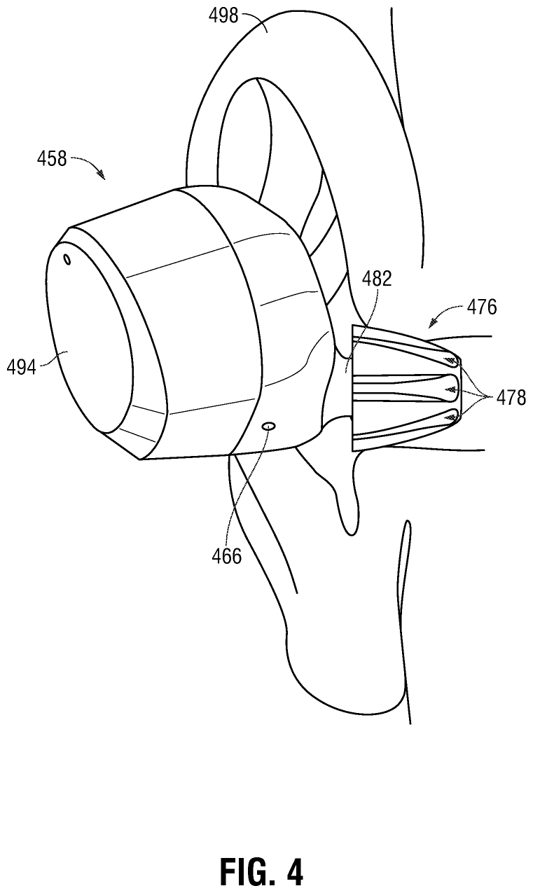

FIG. 4 is a graphic diagram of an in-ear earphone 458 placed within a user's ear 498 and ear canal that includes an earphone in-ear external sound-permitting tip 476 according to another embodiment of the present disclosure. As shown in FIG. 4, the tip extension 482 and earphone in-ear external sound-permitting tip 476 are pressed into the user's ear canal with the in-ear earphone housing 494 being pressed against an interior portion of the user's ear 498 for a comfortable fit therein.

As described herein, the earphone in-ear external sound-permitting tips 476 may have one or more tip channels 478 formed into the earphone in-ear external sound-permitting tip 476. In an embodiment, the tip channels 478 are formed along the external surface of the earphone in-ear external sound-permitting tip 476 and run the length of the earphone in-ear external sound-permitting tip 476 such that an airway is created that extends from the exterior of the earphone in-ear external sound-permitting tip 476 at a distal end of the earphone in-ear external sound-permitting tip 476 and into the user's ear canal at a proximal end of the earphone in-ear external sound-permitting tip 476. In one embodiment, the tip channels 478 run the length of the earphone in-ear external sound-permitting tip 476 and increase in width closer to a proximal end of the earphone in-ear external sound-permitting tip 476 that is within the user's ear canal. In an embodiment, this gradual increase or any changes in the width of the tip channels 478 along the length of the tip channels 478 may provide acoustic characteristics that can be used to change the characteristics of the sound as it passes through the tip channels 478 and into the user's ear. In an embodiment, the formation of the tip channels 478 into the external surface of the earphone in-ear external sound-permitting tips 476 also creates tip channel walls. The tip channel walls may act as a support structure to brace the earphone in-ear external sound-permitting tip 476 between the tip extension of the in-ear earphone and the user's ear canal. In an embodiment, the tip channel walls may be formed perpendicular from the exterior surface of the earphone in-ear external sound-permitting tip 476. In an embodiment, the tip channel walls may be formed at an angle away from the exterior surface of the earphone in-ear external sound-permitting tip 476.

As described herein, the DSP of the in-ear earphones 458 may be operatively coupled to an external microphone 466 that picks up sounds external to the user's ear canal. The input from the external microphone 466 may be processed by the DSP executing the computer-readable program code of the noise cancellation module to reduce the external sounds heard by the user through tip channels 478 formed into the earphone in-ear external sound-permitting tips 476 as described herein. In an embodiment, the reduction of the noise detected at the external microphone 466 and reduced by operation of the DSP as described herein may still allow a certain amount of ambient noise external to the user's ear canal such that the user may still be aware of the user's surroundings. Thus, with an external microphone 466 being placed at an external entrance of the tip channels 478 to capture the sounds immediately external to the user's ear canal as input to the DSP executing the noise cancelling module, the DSP may selectively cancel some of the noise and sounds while still allowing the user to detect some ambient noises thereby providing a level of awareness to the user. Still further, by still having the earphone in-ear external sound-permitting tip 476 placed within the user's ear canals, the location shifting of the external microphone 466 and speaker (e.g., 346, FIGS. 3A and 3B) issues that arise with open ear type earphones thereby maintaining a consistent audio experience for the user. In other embodiments, another external microphone or the external microphone 366 may be used to receive user voice input.

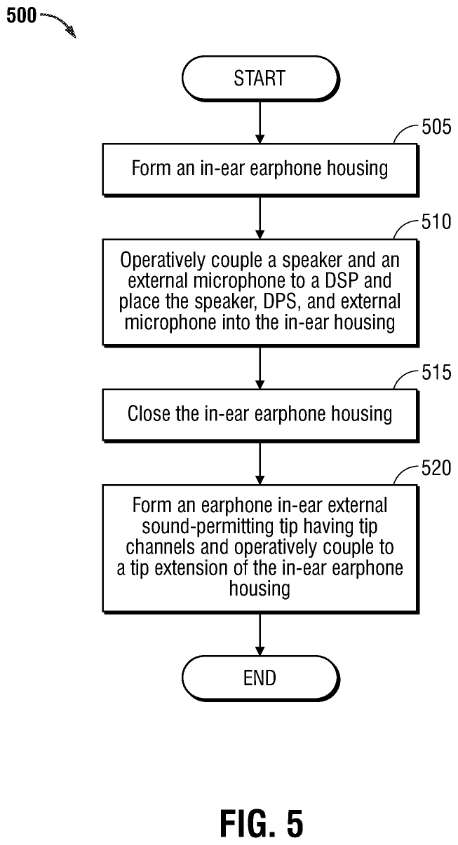

FIG. 5 is a flow chart showing a method 500 of assembling an in-ear earphone that includes an earphone in-ear external sound-permitting tip having tip channels to allow for an amount of noise to enter into the user's ear canal raising awareness to the user's surrounding according to another embodiment of the present disclosure. In an embodiment, the method 500 may include, at block 505, forming an in-ear earphone housing. In an embodiment, the in-ear earphone housing may be made of a plastic. In this embodiment, the in-ear earphone housing may be created using plastic injection molding processes, 3-dimansional (3D) additive manufacturing processes and the like.

As described herein, the housing of the in-ear earphones may further include a tip extension onto which an earphone in-ear external sound-permitting tips described herein may be operatively coupled. In an embodiment, a clipping shelf is formed onto an exterior surface of the tip extension such that an earphone in-ear external sound-permitting tip may be placed over the tip extension and engage with a tip channel formed into an internal barrel of the earphone in-ear external sound-permitting tip.

At block 510, the method 500 further includes operatively coupling a speaker and an external microphone to a digital signal processor (DSP). In an embodiment, the DSP may be operatively coupled to a printed circuit board (PCB) with electrical circuitry being formed onto the PCB via, for example, soldering to operatively couple the speaker and external microphone to the DSP. It is appreciated that other circuitry such as the in-ear earphone radio and in-ear earphone antenna, electrical charging contacts, in-ear earphone PMU, in-ear earphone battery, printed circuit boards, and other circuit design elements may be used to operatively couple these devices and systems to each other. At bock 510, the DSP, one or more external microphones and a speaker may be placed into the in-ear earphone housing.

At block 515, the housing of the in-ear earphone may be closed up. In an embodiment, the in-ear earphone housing may be formed into two separate pieces that, when coupled together, form an entire portion of the in-ear housing. By coupling a second piece of the in-ear housing to the first piece of the in-ear housing, the in-ear housing may be closed, thereby securing the PCB, DSP, external microphone, speaker, in-ear earphone radio, in-ear earphone antenna, electrical charging contacts, in-ear earphone PMU, in-ear earphone battery, printed circuit boards, and other circuit design elements within the in-ear earphone housing.

At block 520, an earphone in-ear external sound-permitting tip may be formed. As described herein, in an example embodiment, the in-ear earphones may be purchased by the user and may include a set of earphone in-ear external sound-permitting tips for each of the in-ear earphones and may include a variety of different sizes and number or size of tip channels that provide the user with different size options and external noise levels presented such that the earphone in-ear external sound-permitting tips may fit comfortably into the user's ear canals and provide desired levels of external noise input. In an embodiment, the earphone in-ear external sound-permitting tip may be made of a rubber, silicone, plastic, or other material that is comfortable to a user when the earphone in-ear external sound-permitting tip is placed within the user's ear canal. In some embodiments, the earphone in-ear external sound-permitting tip may include a plurality of types of materials that are, for example, injected molded together. In these example embodiments, a plastic layer may be formed into a rubber layer such that the plastic adds a structural support to the earphone in-ear external sound-permitting tip. In an embodiment, the forming process of the earphone in-ear external sound-permitting tip may include any injection molding process, compression molding process, or transfer molding process and the like.

As described herein, the formation of the earphone in-ear external sound-permitting tips may include the formation of one or more tip channels being formed into the earphone in-ear external sound-permitting tip. In an embodiment, the tip channels are formed along the external surface of the earphone in-ear external sound-permitting tip and run the length of the earphone in-ear external sound-permitting tip such that an airway is created that extends from the exterior of the earphone in-ear external sound-permitting tip and into the user's ear canal. In an embodiment, the tip channels run the length of the earphone in-ear external sound-permitting tip and increase in width closer to a proximal end of the earphone in-ear external sound-permitting tip that is within the user's ear canal. In an embodiment, this gradual increase or any changes in the width of the tip channels along the length of the tip channels may provide acoustic characteristics that can be used to change the characteristics of the sound as it passes through the tip channels and into the user's ear. The ear tip channels may be any size or geometry in other embodiments. In an embodiment, the formation of the earphone in-ear external sound-permitting tip may include the formation of an internal barrel of the earphone in-ear external sound-permitting tip that includes a clipping channel that interfaces with the clipping shelf formed onto the tip extension as described herein. During operation by the user, the internal barrel of the earphone in-ear external sound-permitting tip may be forced over an external surface of the tip extension until the clipping shelf formed on the tip extension fits into the clipping channel formed on the internal surface of the internal barrel of the earphone in-ear external sound-permitting tip. At this point the method 500 may end and the in-ear earphones with the assortment of differently-sized earphone in-ear external sound-permitting tips may be packaged up and delivered to the user.

The blocks of the flow diagrams of FIG. 5 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An in-ear earphone comprising:
a digital signal processor (DSP);
a speaker operatively coupled to the DSP;
an external microphone operatively coupled to the DSP;
an in-ear earphone power management unit (PMU) to provide power to the DSP the speaker, and the external microphone; and
an earphone in-ear external sound-permitting tip operatively coupled to the in-ear earphone, the earphone in-ear external sound-permitting tip for insertion into a user's ear canal and including tip channels to allow noise to enter into the user's ear canal; and
the DSP to execute computer-readable program code of a noise cancelling module to cancel, from audio input from the external microphone, sounds external to a user's ear canal.

2. The in-ear earphone claim 1 further comprising:
the external microphone placed at an external entrance of one or more tip channels to capture the sounds immediately external to the user's ear canal as input to the DSP executing the noise cancelling module.

3. The in-ear earphone claim 1, wherein the tip channels are formed along the external surface of the earphone in-ear external sound-permitting tip and run the length of the earphone in-ear external sound-permitting tip.

4. The in-ear earphone claim 1, wherein the tip channels run the length of the earphone in-ear external sound-permitting tip and increase in width closer to a proximal end of the earphone in-ear external sound-permitting tip.

5. The in-ear earphone claim 1, further comprising:
the earphone in-ear external sound-permitting tip including an internal barrel to be operatively coupled to a tip extension formed on a housing of the in-ear earphone.

6. The in-ear earphone claim 5 further comprising:
a clipping channel formed within the internal barrel to receive a clipping shelf formed on the tip extension on the housing of the in-ear earphone.

7. The in-ear earphone claim 1 further comprising:
the tip channels including channel walls into the earphone in-ear external sound-permitting tip to provide structural support to the earphone in-ear external sound-permitting tip in order to support the earphone in-ear external sound-permitting tip when inserted into the user's ear canal.

8. A method of forming an in-ear earphone comprising:
forming an in-ear earphone housing including a tip extension;
operatively coupling a speaker and an external microphone to a digital signal processor (DSP) and placing the speaker and DPS into the in-ear earphone housing;
forming an earphone in-ear external sound-permitting tip to be operatively coupled to the tip extension of the housing of the in-ear earphone, the earphone in-ear external sound-permitting tip comprising tip channels to allow noise to enter into the user's ear canal and an internal barrel to be operatively coupled to the tip extension of the in-ear earphone housing.

9. The method of claim 8 further comprising:
an external microphone being formed into a portion of the in-ear earphone housing at an external entrance of one or more tip channels and operatively coupled to the DSP to capture the sounds immediately external to the user's ear canal as input to the DSP executing the noise cancelling module.

10. The method of claim 8, wherein the tip channels are formed along the external surface of the earphone in-ear external sound-permitting tip and run the length of the earphone in-ear external sound-permitting tip.

11. The method of claim 8, wherein the tip channels run the length of the earphone in-ear external sound-permitting tip and increase in width closer to a proximal end of the earphone in-ear external sound-permitting tip.

12. The method of claim 8, further comprising:
a clipping channel formed within the internal barrel of the earphone in-ear external sound permitting tip to receive a clipping shelf formed on the tip extension on the in-ear earphone housing.

13. The method of claim 8 further comprising:
the tip channels including channel walls into the earphone in-ear external sound-permitting tip to provide structural support to the earphone in-ear external sound-permitting tip when the earphone in-ear external sound-permitting tip is inserted into the user's ear canal.

14. An in-ear earphone operatively coupled to an information handling system comprising:
a digital signal processor (DSP);
an in-ear earphone wireless radio operatively coupled to the DSP to operatively couple the in-ear earphone to the information handling system via an in-ear earphone wireless antenna;
a speaker operatively coupled to the DSP;
an in-ear earphone power management unit (PMU) to provide power to the DSP and the speaker;
the DSP, in-ear earphone wireless radio, speaker, and in-ear earphone PMU being placed within an in-ear earphone housing including a tip extension; and
an earphone in-ear external sound-permitting tip operatively coupled to the in-ear earphone on the tip extension of the in-ear earphone housing, the earphone in-ear external sound-permitting tip comprising tip channels to allow noise to enter into a user's ear canal when the tip extension sound permitting top are inserted into the user's ear canal; and
the DSP to execute computer-readable program code to provide audio output from the information handling system via the speaker.

15. The in-ear earphone of claim 14 further comprising:
an external microphone placed at an external entrance of one or more tip channels to capture the sounds immediately external to the user's ear canal as input, wherein the DSP executes computer-readable program code instructions of a noise cancelling module to cancel, from audio input from the external microphone, sounds external to a user's ear canal.

16. The in-ear earphone of claim 14, wherein the tip channels are formed along the external surface of the earphone in-ear external sound-permitting tip and run the length of the earphone in-ear external sound-permitting tip.

17. The in-ear earphone of claim 14, wherein the tip channels run the length of the earphone in-ear external sound-permitting tip and increase in width closer to a proximal end of the earphone in-ear external sound-permitting tip.

18. The in-ear earphone of claim 17 further comprising:
the earphone in-ear external sound-permitting tip including an internal barrel with a clipping channel to be operatively coupled to the tip extension formed on the in-ear earphone housing.

19. The in-ear earphone of claim 18 further comprising:
the clipping channel formed within the internal barrel to receive a clipping shelf formed on the tip extension on the in-ear earphone housing.

20. The in-ear earphone of claim 14, wherein the earphone in-ear external sound-permitting tip comprises plastic to provide structural support when the earphone in-ear external sound-permitting tip is inserted into the user's ear canal.
